(19) United States
(12) Patent Application Publication
(10) Pub. No.: US 2024/0308820 A1
(43) Pub. Date: Sep. 19, 2024

(54) Dolly Apparatus for Moving a Load

(71) Applicant: Paul Lapointe, New Carlisle (CA)

(72) Inventor: Paul Lapointe, New Carlisle (CA)

(21) Appl. No.: 18/394,381

(22) Filed: Dec. 22, 2023

Related U.S. Application Data
(60) Provisional application No. 63/490,922, filed on Mar. 17, 2023.

(51) Int. Cl. B66F 5/02

(52) U.S. Cl. CPC B66F 5/025

(57) ABSTRACT

An apparatus useful for moving a load. The apparatus includes a carriage with two frames, each one has a hinge end. The frames are hingeably connected to each other at the hinge end. One frame is mounted on a rail to move the carriage therealong. The other frame is moveable relative to the first frame about the hinge end. A jack assembly is connected to the frames and is actuatable to move one frame relative to the other frame about the hinge end. A brake assembly is located away from the hinge end and has a brake plate member connected to one frame for resilient axial movement. The brake assembly also has a brake plate stopper connected to the first frame, and is moveable between a carriage stopping configuration, in which the brake plate stopper engages the brake plate member, and a carriage moving configuration in which the brake plate stopper is retracted away from the brake plate member.

### CROSS-REFERENCE TO RELATED APPLICATION

Priority is hereby claimed to previously filed U.S. Provisional Patent application Ser. No. 63/490,922, filed on Mar. 17, 2023, the entire contents of which are hereby incorporated by reference.

### TECHNICAL FIELD

The present generally concerns apparatus for moving loads, and more particularly to an apparatus for controlled movement of loads along an inclined track system.

### BACKGROUND

Using track systems to move loads from a loading point to an un-loading point are well known and widely used in, for example, the construction, agricultural and storage industries. Oftentimes, the loads are moved against the force of gravity and as such require braking systems that can control the movement of the load so as to prevent loss of control, which may result in damage to the load and injury to the user.

Dolly carts are well-known and widely used for hand operated movement of loads in a location. Generally speaking, conventional dollies include a base on which the load is placed and an elongate frame against which additional multiple loads can be stacked. Wheels, which are located at the bottom of the dolly together with a handle system located away from the load takes advantage of a hinging movement towards the user in which the user can stack the dolly and then pull backwards about the wheels and then push forward so as to move the load. While this apparatus is easy to use and generally inexpensive, it does have a number of drawbacks which limits its use.

An additional and more significant drawback is the load limits available to the dolly. As is known in the art, the load's movement is limited by the user's physical strength. Furthermore, the load amount is limited to the length and width of the elongate frame, and indeed the load platforms at the dolly's base. This makes maneuvering around corners extremely difficult.

Thus, there is clearly a need for a controllable load-moving apparatus which can operate independent of a power source, which can move loads on an incline, around obstacles and along an extended linear rail system.

### BRIEF SUMMARY

We have significantly reduced, or essentially eliminated, the problems noted above by designing an apparatus which includes a carriage that rolls along a rail guide system for controlled movement of loads, either independent of a power source or with a power source, thereby allowing use of the apparatus in areas where a power source is not available. To prevent dangerous and uncontrolled movement of the load during lifting, we have designed a novel and unobvious braking system which is included in the framing system and which controls uncontrolled movement along a vertical path of travel. The braking system is a cam system includes two opposing rotatable spring-operated brake plates which engage a shooter rod to prevent the load from accidently dropping downwards during a load moving operation. Advantageously, the apparatus can be operated manually, which means it can be used in remote areas without electricity. The apparatus is inexpensive to manufacture and can be quickly and easily assembled on-site, and quickly modified to permit its use in a variety of load moving situations.

Our dolly apparatus is designed to carry heavy loads. The dolly can be used manually without need for electrical power. This means the dolly can be used remotely. Also, the dolly apparatus can be used to move loads on an incline. The dolly apparatus includes its own extended linear rail system and stabilizer bars to keep it centered in the rails. Also, the dolly apparatus can include a Jack system to keep the load level on inclines. Furthermore, the dolly apparatus includes its own braking system that the user has full control over as the load moves up or down the incline. Finally, the dolly apparatus can be dismantled quickly to move it to another job location.

Accordingly, in one embodiment there is provided an apparatus for moving a load, the apparatus comprising:
a carriage having a first frame and a second frame, each of the frames having a hinge end for hingeably connecting the frames together, the first frame being adapted for mounting on a rail member to move the carriage therealong, the second frame being moveable relative to the first frame about the hinge end;
a jack assembly connected to the first and second frames, the jack assembly being actuatable to move the second frame relative to the first frame about the hinge end; and
a brake assembly located away from the hinge end, the brake assembly having a brake plate member resiliently connected to the first frame for axial movement relative thereto, and a brake plate stopper moveably connected to the first frame, the brake plate stopper being moveable between a carriage stopping configuration, in which the brake plate stopper abuttingly engages the brake plate member, and a carriage moving configuration in which the brake plate stopper is retracted away from the brake plate member.

In one example, the first frame is generally square-shaped and includes: i) two proximal upstanding supports, each having first and second hinges for hingeably connecting the second frame thereto, and ii) two distal upstanding supports for receiving therein the first frame. The first frame further includes a first frame extension disposed proximally relative to the first frame, and a second frame extension disposed distally relative to the first frame, the first frame extension having a first cross bar connected thereto, the second frame extension having a second cross bar connected thereto. The first frame includes: first and second side wheel sets axially connected to the first frame for rotation about a first axis; a proximal wheel set connected to the first cross bar; and a distal wheel set connected to the second cross bar, the proximal and distal wheel sets being mounted for axial rotation about a second axis disposed generally orthogonal relative to the first axis.

In one example, the first and second side wheel sets include eight wheels.

In another example, the proximal wheel set includes two spaced apart wheels connected to the ends of the first cross bar, and the distal wheel set includes two spaced apart wheels connected to the ends of the second cross bar.

In yet another example, the rail member includes two spaced apart and substantially parallel rails for receiving therein the wheels for rolling engagement therein.

In one example, the jack assembly includes: an actuator screw connected to the jack assembly to move the jack assembly between a collapsed configuration and an extended configuration; first jack assembly connector end connected to a jack assembly cross bar interconnected with the first frame; a first frame jack assembly connector connected to the first frame; and a second frame jack assembly connector connected to the second frame, the first and second frame jack assembly connectors being operably connected to the actuator screw.

In one example, the brake assembly includes: first and second brake plate members connected for axial movement to first and second spaced apart upstanding support plates, the first and second support plates being connected to a first frame end; first and second brake plate stopper rods slidably mounted in the respective first and second support plates; first and second resilient members connected the respective first and second brake plate members to the respective support plates; and an actuator bar interconnects the first and second brake plate members to the first frame end to axially move the brake plate members. The first and second resilient members are springs. The actuator bar is in communication with an actuator handle. The first and second brake plate stopper rods are in communication with an elongate brake controller rod having a brake controller end located at a second frame end located away from the first frame end.

In one example, the rail member is disposed at an angle relative to the ground.

In another example, the rail member is disposed generally parallel relative to the ground.

In yet another example, the rail member is disposed generally orthogonal relative to the ground.

In yet another example, the apparatus is a dolly apparatus.

Accordingly in another embodiment, there is provided a brake apparatus for a carriage, the apparatus comprising:
first and second brake plate members connected for axial movement to first and second spaced apart upstanding support plates, the first and second support plates being connected to a first frame end;
first and second brake plate stopper rods slidably mounted in the respective first and second support plates;
first and second resilient members connected the respective first and second brake plate members to the respective support plates; and
an actuator bar interconnects the first and second brake plate members to the first frame end to axially move the brake plate members

Accordingly, in another embodiment there is provided a dolly for moving a load, the dolly comprising:
a carriage having a first frame and a second frame, each of the frames having a hinge end for hingeably connecting the frames together, the first frame being adapted for mounting on a rail member to move the carriage therealong, the second frame being moveable relative to the first frame about the hinge end;
a jack assembly connected to the first and second frames, the jack assembly being actuatable to move the second frame relative to the first frame about the hinge end; and
a brake assembly located away from the hinge end, the brake assembly having a brake plate member resiliently connected to the first frame for axial movement relative thereto, and a brake plate stopper moveably connected to the first frame, the brake plate stopper being moveable between a carriage stopping configuration, in which the brake plate stopper abuttingly engages the brake plate member, and a carriage moving configuration in which the brake plate stopper is retracted away from the brake plate member.

In one example, the first frame is generally square-shaped and includes: i) two proximal upstanding supports, each having first and second hinges for hingeably connecting the second frame thereto, and ii) two distal upstanding supports for receiving therein the first frame.

Accordingly, in another embodiment, there is provided a brake apparatus for a carriage, the apparatus comprising:
first and second brake plate members connected for axial movement to first and second spaced apart upstanding support plates, the first and second support plates being connected to a first frame end;
first and second brake plate stopper rods slidably mounted in the respective first and second support plates;
first and second resilient members connected the respective first and second brake plate members to the respective support plates; and
an actuator bar interconnects the first and second brake plate members to the first frame end to axially move the brake plate members.

### BRIEF DESCRIPTION OF THE DRAWINGS

These and other features of that described herein will become more apparent from the following description in which reference is made to the appended drawings wherein:

FIG. 1 is a perspective view of an embodiment of a dolly apparatus for moving a load along a guide rail;

FIG. 2 is a perspective side view of a carriage showing a load carrying frame angled away from a wheeled frame;

FIG. 3 is a side view of the carriage connected to a hinge and to a jack assembly;

FIG. 4 is a close-up side view of the carriage and the jack assembly;

FIG. 5 is a perspective side view of the wheeled frame with the jack assembly removed;

FIG. 6 is a simplified plan view of the carriage engaged in the guide rail;

FIG. 7 is a partial cutaway plan view of the carriage showing location of a brake assembly;

FIG. 8 is a simplified plan view of the carriage showing location of the wheels and the brake assembly;

FIG. 9 is a simplified partial cutaway plan view of the carriage showing the location of the wheels' axles;

FIG. 10 is a simplified side view of the second frame showing the subframe and the location of the brake assembly;

FIG. 11 is a detailed partial longitudinal cut through side view of part of the subframe and an actuator screw;

FIG. 12 is a side view of the brake assembly showing a brake plate disposed in a moving configuration;

FIG. 13 is a perspective side view of the brake assembly showing a brake plate in a braking configuration with a shooter rod in an abutting engagement with the brake plate; and

FIG. 14 is a perspective side view of the brake assembly showing the brake plate in a moving configuration with the shooter rod retracted away from the brake plate.

### DETAILED DESCRIPTION

### Definitions

Unless otherwise specified, the following definitions apply:

The singular forms “a”, “an” and “the” include corresponding plural references unless the context clearly dictates otherwise.

As used herein, the term “comprising” is intended to mean that the list of elements following the word “comprising” are required or mandatory but that other elements are optional and may or may not be present.

As used herein, the term “consisting of” is intended to mean including and limited to whatever follows the phrase “consisting of”. Thus, the phrase “consisting of” indicates that the listed elements are required or mandatory and that no other elements may be present.

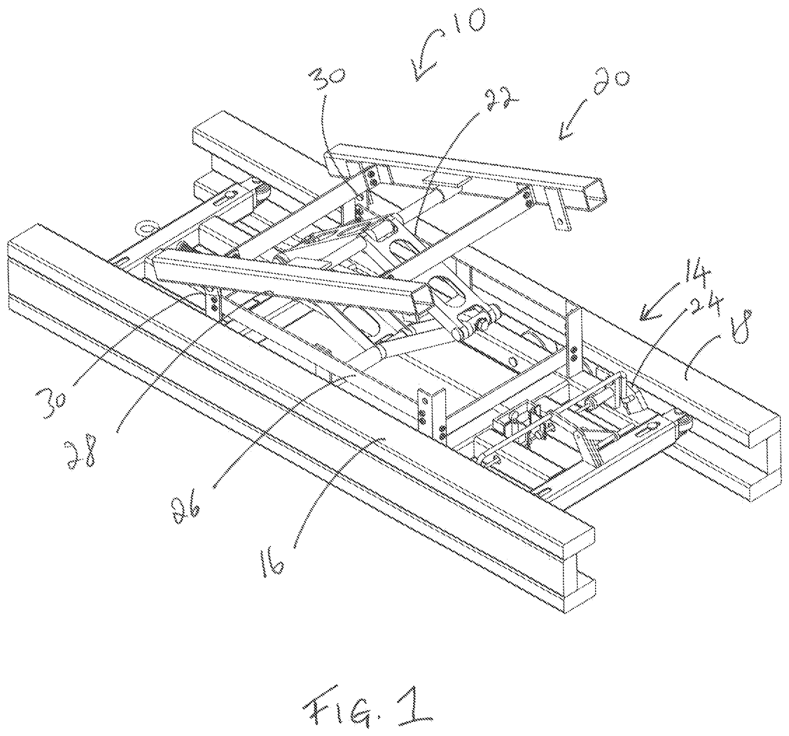

Referring to FIGS. 1 through 3, there is shown generally at 10 an apparatus for moving a load. The apparatus 10 is typically called a “dolly” and is useful to move a load (not shown) along a guide rail member 14. The guide rail member 14 can be located either on an incline, vertically or horizontally relative to the ground. The apparatus 10 is generally used to move loads from an on-loading point to an off-loading point, and, in the case of an inclined or vertical rail member 14, against the downward force of gravity. The guide rail member 14 includes first and second spaced apart elongate guide rails 16, 18. When viewed in cross section, each of the guide rails 16, 18 are generally C-shaped. The rails 16, 18 can be any length allowing loads to be moved over large distances. In some instances (not shown), the guide rails 16, 18 can be curved to avoid obstacles such as buildings and the like. Thus, the rail member 14 can be disposed at an angle relative to the ground; can be disposed generally parallel relative to the ground; or can be disposed generally orthogonal relative to the ground.

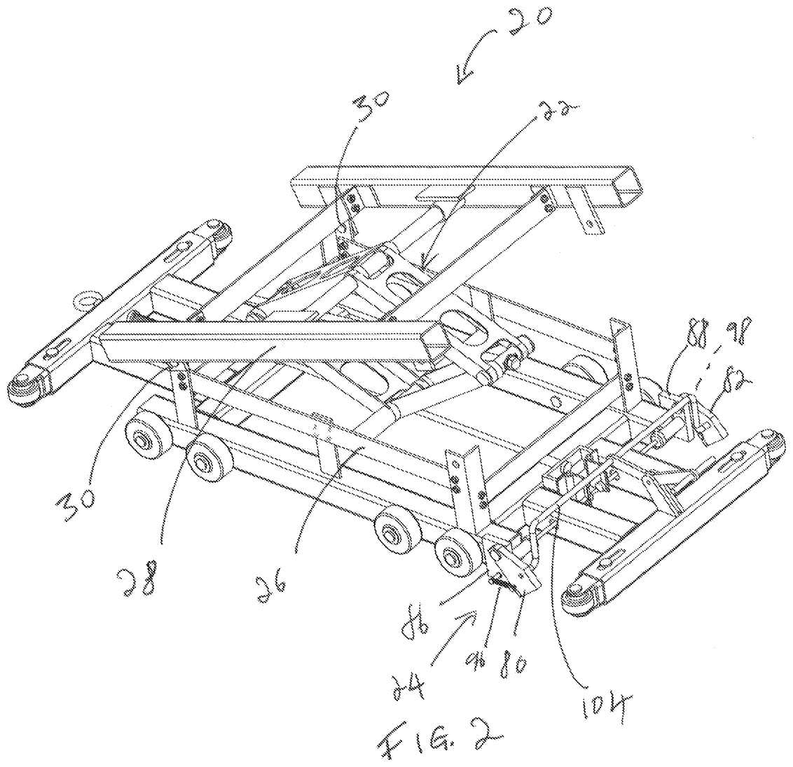

As best seen in FIG. 2, broadly speaking, the apparatus 10 includes a carriage 20, a jack assembly 22 and a brake assembly 24. The carriage 20 includes a first frame 26 and a second frame 28. The second frame 28 is mounted on the guide rail member 14 to move the carriage 20 therealong. The frames 26, 28 each has a hinge end 30 to which they are connected so that the second frame 28 can hingeably move relative to the first frame 26, The first frame 26 and the second frame 28 are hingeably connected to each other at the hinge end 30. The first frame 26 is moveable relative to the second frame 28 about the hinge end 30.

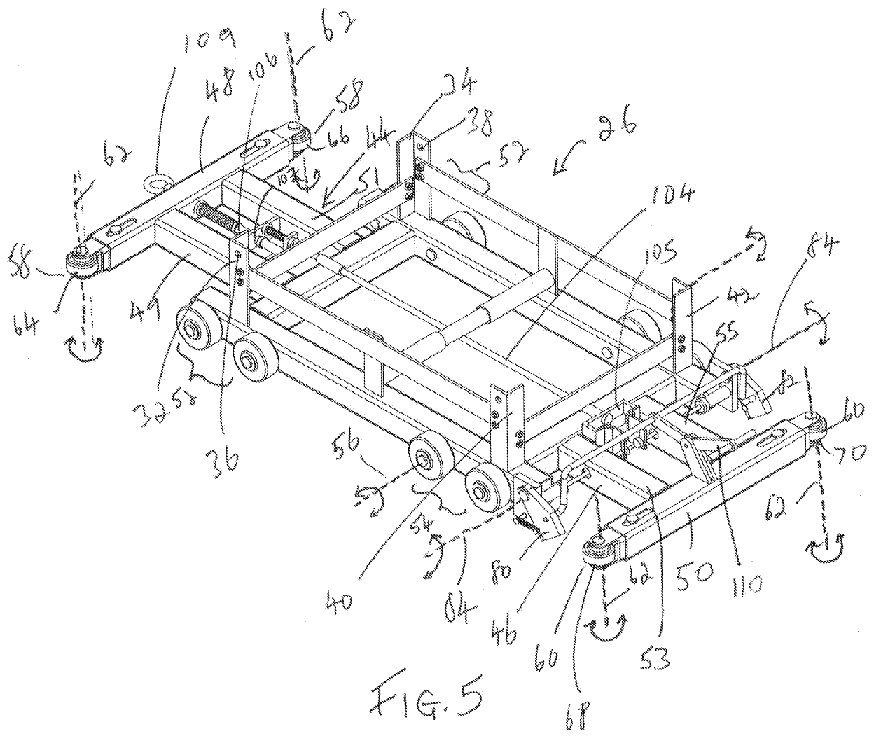

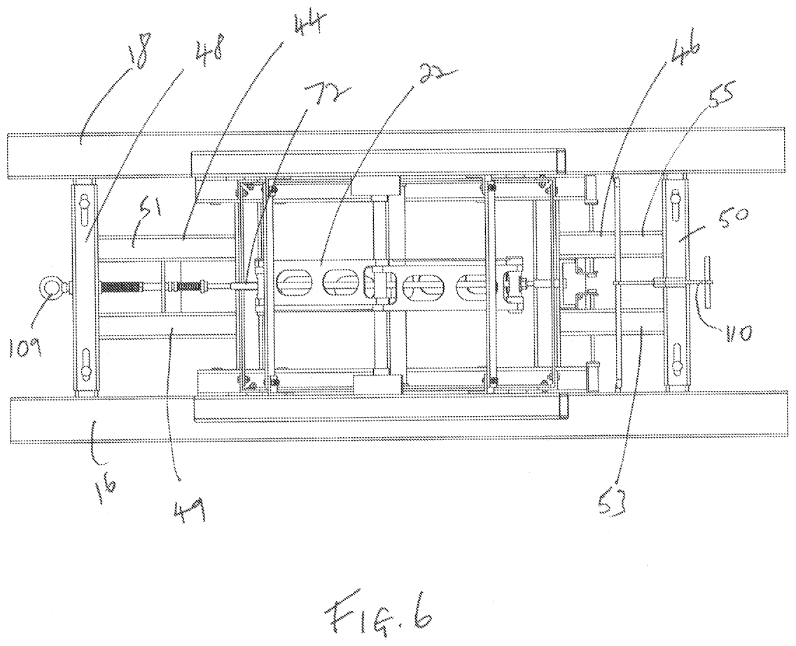

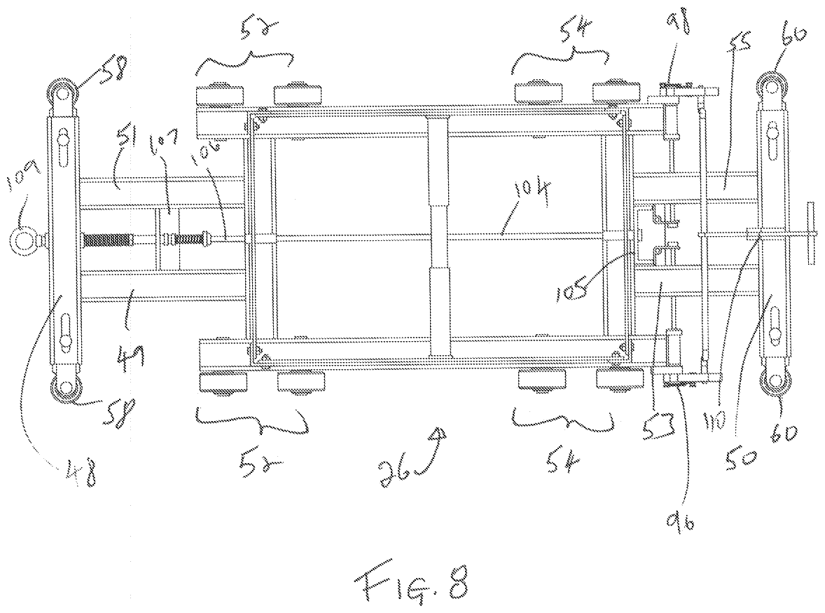

As best seen in FIGS. 5 through 9, the first frame 26 is generally square-shaped and includes two proximal upstanding supports 32, 34 which have first and second hinges 36, 38 to hingeably connect the second frame 28 thereto. Two distal upstanding supports 40, 42 are located away from the two proximal upstanding supports 32, 34. The first frame 26 also includes a first frame extension 44 that is disposed proximally relative to the first frame 26. A second frame extension 46 is disposed distally relative to the first frame 26. The first frame extension 44 has a first cross bar 48 connected thereto. The second frame extension 46 has a second cross bar 50 connected thereto. When viewed from above, as best seen in FIG. 6, the apparatus 10 is generally symmetrical which lends itself to a balanced apparatus thereby reducing the risk of lateral movement during load movement.

Referring specifically to FIG. 5, the first frame 26 includes first and second side wheel sets 52, 54 that axially connected to the first frame 26 for rotation about a first axis 56. A proximal wheel set 58 is connected to the first cross bar 48, and a distal wheel set 60 is connected to the second cross bar 50. The proximal and distal wheel sets 58, 60 are mounted for axial rotation about a second axis 62 that is disposed generally orthogonal relative to the first axis 56. In one example, the axial relationship is 90-degrees. Also, in the example shown, the first and second side wheel sets 52, 54 include eight wheels, although a person of ordinary skill in the art will readily recognize that any number of wheels are permissible and depend largely on the carriage size and loads to be moved

Still referring to FIG. 5, the proximal wheel set 58 includes two spaced apart wheels 64, 66 that are connected to the ends of the first cross bar 48. Similarly, the distal wheel set 54 includes two spaced apart wheels 68, 70 that connected to the ends of the second cross bar 50. The two spaced apart and substantially parallel rails are adapted to receive therein the wheels for rolling engagement therein.

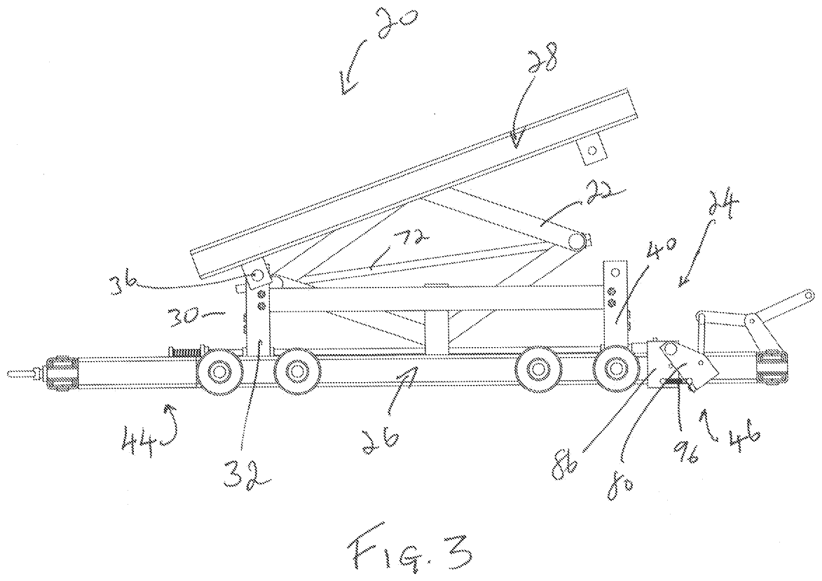

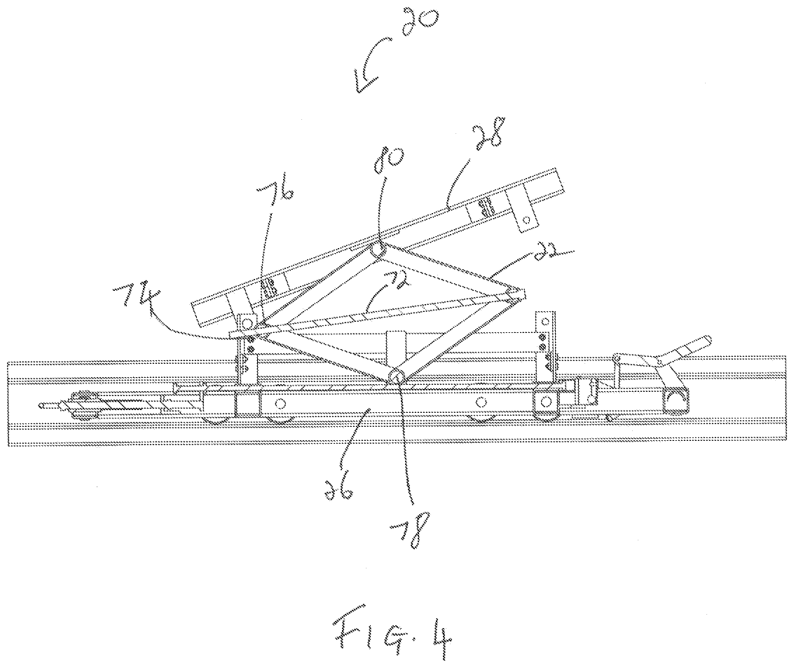

Referring now to FIGS. 3 and 4, the jack assembly 22 is connected to the first and second frames 26, 28 and is actuatable to move the second frame 28 relative to the first frame 26 about the hinge end 30. The jack assembly 22 includes an actuator screw 72 which is connected to the jack assembly 22 for movement between a collapsed configuration and an extended configuration. A first jack assembly connector end 74 is connected to a jack assembly cross bar 76 interconnected with the first frame 26. A first frame jack assembly connector 78 is connected to the first frame 26. A second frame jack assembly connector 80 is connected to the second frame 28. The first and second frame jack assembly connectors 78, 80 are operably connected to the actuator screw 72.

Referring now to FIGS. 2, 5 and 12 to 14, the brake assembly 24, which is essentially a cam arrangement, is located away from the hinge end 30. The first and second brake plate members 80, 82 are connected for axial movement about a plate axis 84 to first and second spaced apart upstanding support plates 86, 88 that are connected to first frame end 90. First and second brake plate stopper rods 92, 94 are slidably mounted in the respective first and second support plates 86, 88. First and second resilient spring members 96, 98 are connected the respective first and second brake plate members 80, 82 to the respective support plates 86, 88 via two connector rods 100, 102. An actuator bar 104 interconnects the first and second brake plate members 80, 82 to the first frame end 90 to axially move the brake plate members 80, 82. The first and second resilient members 96, 98 are coiled springs. A person of ordinary skill in the art will recognize that other resilient members can be used. A person of ordinary skill in the art will readily recognize that the springs 96, 98 can be connected to the main body frame to permit additional adjustments and support to the brake plate members 80, 82.

Referring to FIG. 5, the actuator bar 104 is in communication with an actuator handle 106. The first and second brake plate stopper rods 92, 94 are in communication with an elongate brake controller rod 108 having a brake controller end 110 located at a second frame end 112 located away from the first frame end 90.

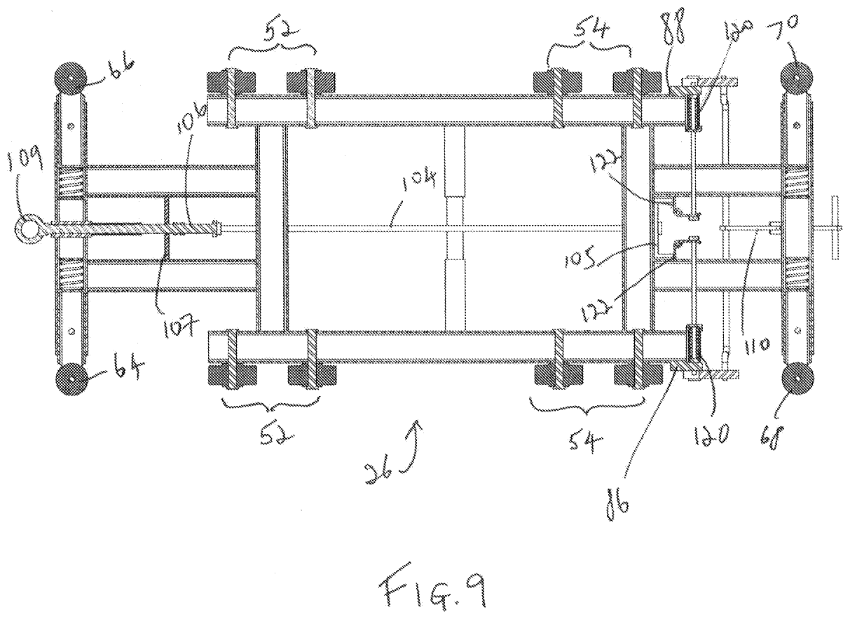

Turning back to FIGS. 6 through 10, the first and second frames 26, 28 of the carriage 20 have a unique configuration that is particularly well suited to carry the load along the guide rail member 14. The first and second frames 26, 28 both include a number of cross bars 120 that provide strength to the frames and anchors for the various components such as the brake assembly and the jack assembly. As best seen in FIG. 9, each one of the wheel sets includes an axle for connection to the first frame 26.

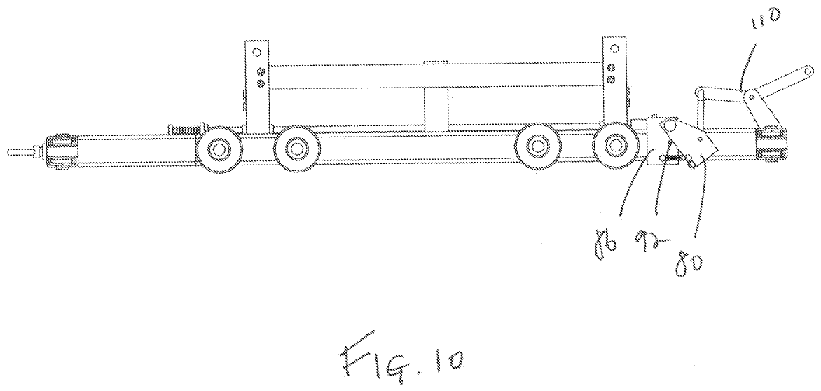

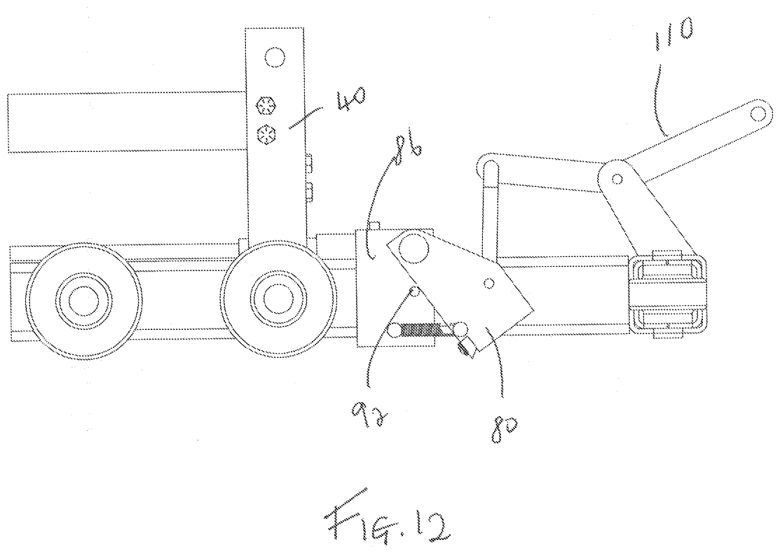

As seen specifically in FIGS. 10 and 12, the actuator for the brake assembly is shown as part of an Y-shaped member 110.

Our guide rail has many features that are designed to be part of the apparatus. Specifically, the rails used to make the track system are calculated for thickness and width for the apparatus to operate in an optimal manner. The guide rail system is built for strength, stability, and accessibility like the apparatus that was built for it so therefore it must be recognized the rail system is a unique part of the apparatus built for it because of the unique brake system that was designed and built for the apparatus to work together with the rail system.

The rails that are used for the tracks can be made from many types of material such as, for example, wood. This allows for strength, low price, stability during use, and accessibility.

### Operation

Broadly referring now to FIGS. 1 through 14, operation of the dolly apparatus 10 will now be described. An operator locates the apparatus into the guide rail system and engages the braking assembly to maintain the apparatus in a stationary configuration until loaded.

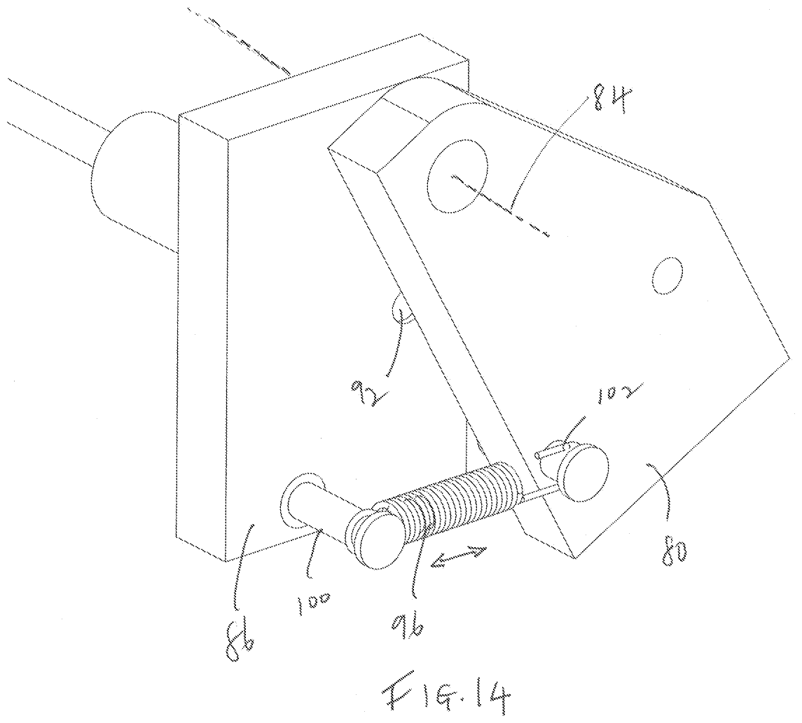

Referring to FIG. 5 and FIG. 14, when there is no tension on the toolbar 106, the brake system is in the “ON” position. The brake plates are disposed downwardly towards the ground so that the operator can attach a pull line to the towbar 106. The towbar 106 has a stopper plate that is welded to the stabilizer bars that are attached to the mainframe.

As best seen in FIG. 5, a stopper plate carries the load off the towbar 106. The towbar 106 is generally a ½-inch tempered rod steel that is spring loaded to keep it in passing through a plate. A nut is installed which can be adjusted to be synchronized to work with the rod 104 when pulling the load.

Still referring to FIG. 5, the tow bar 106 is spring loaded to keep the pressure towards rod. The rod 104 is located adjacent the plate.

Referring back to FIGS. 5, 7, 9 and again to 11, the rod 104 is pushed by the rod 106. As seen in FIG. 5, the rod 104 pushes against the plate.

As seen in FIG. 10, the hinge plates H are pushed by the plate 80 and the hinge plates that are pushed by the plate to pull the pins 92 out of the cams, so as to drop the brake plates down in the “ON” position as shown in FIG. 14.

In this configuration with no load on the tow bar, it is not possible to put the apparatus into reverse or backup until the brake system is first unlocked, i.e., is disengaged. In order to unlock the brake system, the apparatus must be moved forward. When the operator is able to move the apparatus forward, the brake system can be released as seen in FIG. 2 when the operator is able to release the pressure off the brake plates 80, 82.

Referring now to FIG. 12, the Y-shaped piece (operating as a mechanical lever) 110 must first be lifted.

Referring now to FIGS. 2, 12 and 13, to release the brake pads 80 when pulling the apparatus forward, by releasing the force of the brake plates, the operator can pull down or push down on the lever 110, as soon, as in FIG. 12, when pushing down the lever 110, it lifts up a bar 104 as shown in FIG. 2.

As seen in FIG. 2 and FIG. 9, the bar 104 is connected to each side of the brake plates 80, 82. The bar 104 is designed to lift the two plates simultaneously and sufficiently high to allow the pins 92 to be pulled back out again from the cams.

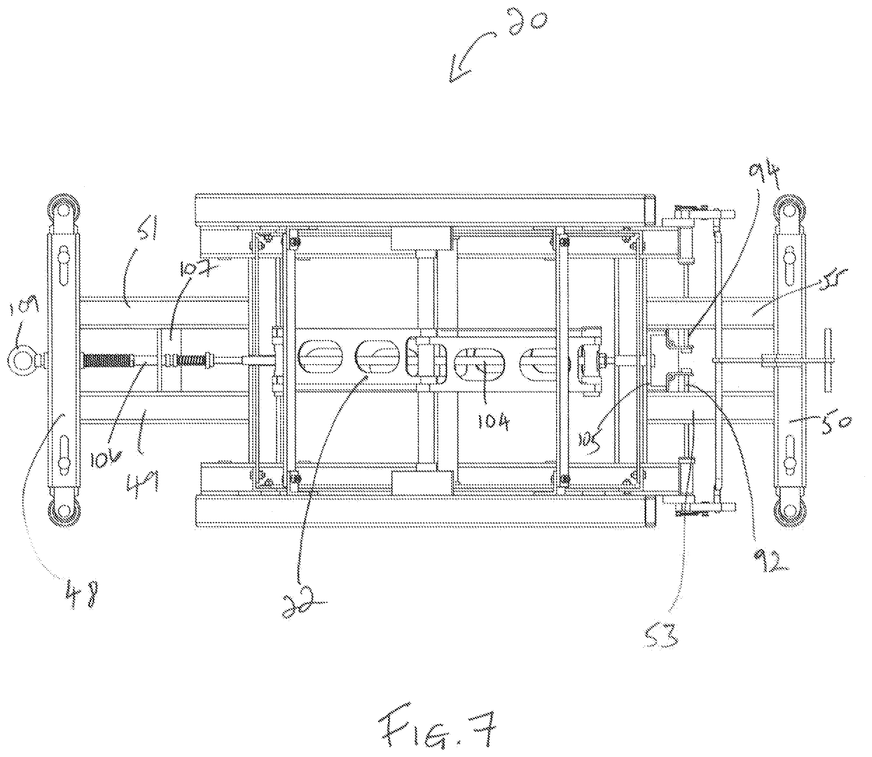

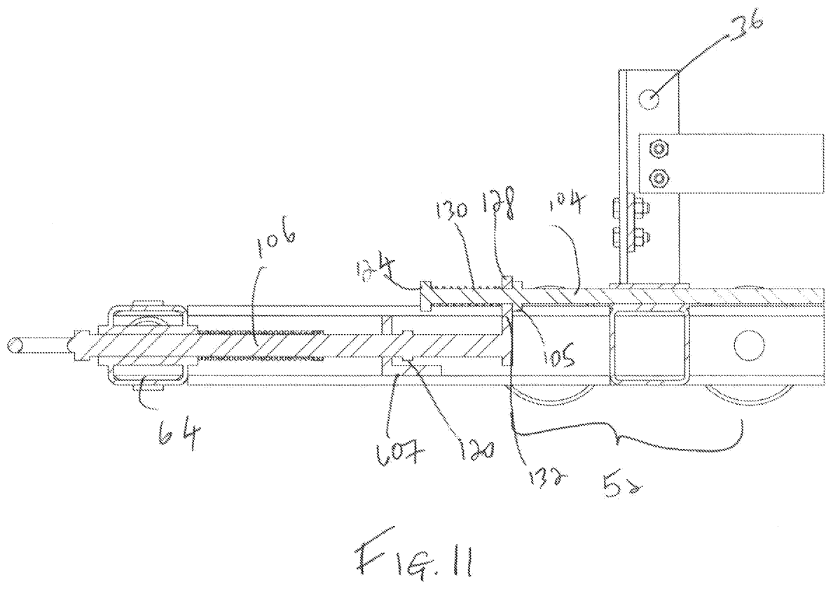

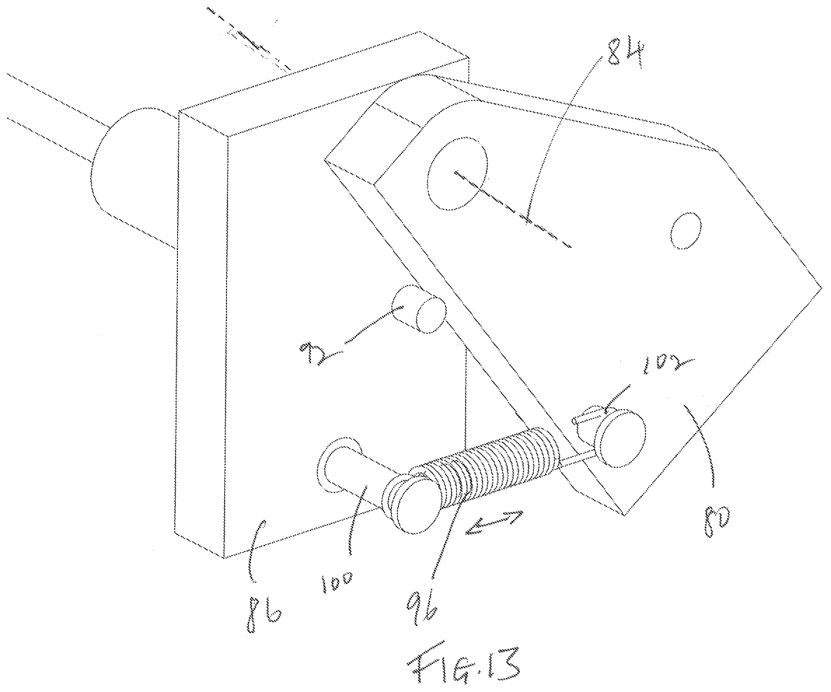

As shown in FIG. 13, the brake plates are reset again to the “OFF” position. If the operator wishes to re-engage the brake system to go back-up and to secure the load, the rod is pushed by tapping at the front of A in FIG. 11 in order for the rod to be able to pull the pins back out again as shown in FIG. 7 as pin order to drop their brake plates to the “ON” position as shown in FIG. 14 so the apparatus is secured again moving forward.

One major advantage of our dolly apparatus is that it can be operated safely and securely, whether moving a load up or down an incline or indeed a vertical rail. Furthermore, it is not necessary to engage the brake system engage at all times.

If a winch is used to pull the apparatus up because the towbar is designed to work with the brake system.

Referring back to FIG. 11, no load is detected or there is no tension on the toolbar 106 a heavy-duty spring is installed to push rod to drop the brake plates, as shown in FIG. 14, to the “ON” position. The brakes can only be released when the operator has fixed the problem and is in control of the apparatus again and can move the load forward.

Furthermore, and advantageously, when using the apparatus in manual mode, the brake system functions so that for every inch forward the apparatus moves, the operator is able to pull or push the apparatus with a load on and thus the apparatus will stay in the stopped position. There is no electrical power needed at any time for any of the functions to work.

When the apparatus is being used on a flat, ground level with no tension applied to the towbar 106, as shown in FIG. 11, the apparatus is stationary and cannot be pushed backwards and the brake plates 80 are configured as shown in FIG. 13. In this configuration, the pins cannot reset unless there is a gap such that the rod can push back up again. However, in order to so, the rod 106 must be locked out as shown in FIG. 11.

To lock out the towbar so as to use the apparatus in reverse, the operator must first move the rod 106 forward to move together and create a gap so that the rod 104 can be lifted. This engages the brake system to the “ON” position. The rod 104 travels through from front to rear with the guides holding it in place. As seen in FIG. 11, the rod 104 is controlled where the main springs are located to push the rod 104 down and engage the system for the brakes with speed and force.

Referring still to FIG. 11, the spring is installed to hold the weight of the rod 104 in an “UP” configuration due to gravitational force. The spring keeps the weight off the rod from pushing against the cam, as seen in FIG. 5 by doing this also releases the force to the hinge plates, as shown in FIG. 7, now that the force is released the spring-loaded cams in FIG. 9, which can now push the pins out as shown in FIG. 7 when pulling down or pushing down on the lever 110 as shown in FIG. 10. This resets the pins 92 again, as shown in FIG. 13, so that they are maintained in that position until they can be reset when the apparatus moves back up again.

When using the apparatus under normal conditions, the pin, as seen in FIG. 11, is not installed to lock the system. When the apparatus is installed from the front, the brake system must be locked out so that the apparatus can be installed from the back. In this case, the brake plates are lifted and stay in position as shown in FIG. 13 in order to install the apparatus.

Moreover, the brake plate members 80, 82 are rotatable about the plate axis 84, while the brake plate stoppers 92, 94 are moveable between a carriage stopping configuration, in which the brake plate stopper rods 92, 94 abuttingly engage the brake plate member 80, as seen in FIG. 13, and a carriage moving configuration in which the brake plate stopper 82 is retracted away from the brake plate member 80.

When the brake assembly is engaged, the carriage 20 is retarded from being moved uphill from the first stop end to the second stop end. When the brake system is engaged, the moveable frame is retarded from moving downhill by force of gravity.

Furthermore, to reiterate the advantages of our dolly apparatus, it can be used to load and move heavy loads; it can be used manually with no need for electrical power; it can move loads on an incline; it includes its own, independent extended linear rail system; it is equipped with stabilizer bars to keep it centered in its rails; it includes a Jack system to keep the load level on inclines; it includes its own braking system that the operator has full control over moving the load up or down; it can be dismantled quickly to move to another job location.

### OTHER EMBODIMENTS

From the foregoing description, it will be apparent to one of ordinary skill in the art that variations and modifications may be made to the embodiments described herein to adapt it to various usages and conditions.

What is claimed is:

1. An apparatus for moving a load, the apparatus comprising:
a carriage having a first frame and a second frame, each of the frames having a hinge end for hingeably connecting the frames together, the first frame being adapted for mounting on a rail member to move the carriage therealong, the second frame being moveable relative to the first frame about the hinge end;
a jack assembly connected to the first and second frames, the jack assembly being actuatable to move the second frame relative to the first frame about the hinge end; and
a brake assembly located away from the hinge end, the brake assembly having a brake plate member resiliently connected to the first frame for axial movement relative thereto, and a brake plate stopper moveably connected to the first frame, the brake plate stopper being moveable between a carriage stopping configuration, in which the brake plate stopper abuttingly engages the brake plate member, and a carriage moving configuration in which the brake plate stopper is retracted away from the brake plate member.

2. The apparatus, according to claim 1, in which the first frame is generally square-shaped and includes: i) two proximal upstanding supports, each having first and second hinges for hingeably connecting the second frame thereto, and ii) two distal upstanding supports for receiving therein the first frame.

3. The apparatus, according to claim 2, in which the first frame further includes a first frame extension disposed proximally relative to the first frame, and a second frame extension disposed distally relative to the first frame, the first frame extension having a first cross bar connected thereto, the second frame extension having a second cross bar connected thereto.

4. The apparatus, according to claim 3, in which the first frame includes:
first and second side wheel sets axially connected to the first frame for rotation about a first axis;
a proximal wheel set connected to the first cross bar; and
a distal wheel set connected to the second cross bar, the proximal and distal wheel sets being mounted for axial rotation about a second axis disposed generally orthogonal relative to the first axis.

5. The apparatus, according 4, in which the first and second side wheel sets include eight wheels.

6. The apparatus, according to claim 4, in which the proximal wheel set includes two spaced apart wheels connected to the ends of the first cross bar, and the distal wheel set includes two spaced apart wheels connected to the ends of the second cross bar.

7. The apparatus, according to claim 4, in which the rail member includes two spaced apart and substantially parallel rails for receiving therein the wheels for rolling engagement therein.

8. The apparatus, according to claim 1, in which the jack assembly includes:
an actuator screw connected to the jack assembly to move the jack assembly between a collapsed configuration and an extended configuration;
first jack assembly connector end connected to a jack assembly cross bar interconnected with the first frame;
a first frame jack assembly connector connected to the first frame; and
a second frame jack assembly connector connected to the second frame, the first and second frame jack assembly connectors being operably connected to the actuator screw.

9. The apparatus, according to claim 1, in which the brake assembly includes:
first and second brake plate members connected for axial movement to first and second spaced apart upstanding support plates, the first and second support plates being connected to a first frame end;
first and second brake plate stopper rods slidably mounted in the respective first and second support plates;
first and second resilient members connected the respective first and second brake plate members to the respective support plates; and
an actuator bar interconnects the first and second brake plate members to the first frame end to axially move the brake plate members.

10. The apparatus, according to claim 8, in the first and second resilient members are springs.

11. The apparatus, according to claim 8, in which the actuator bar is in communication with an actuator handle.

12. The apparatus, according to claim 8, in which the first and second brake plate stopper rods are in communication with an elongate brake controller rod having a brake controller end located at a second frame end located away from the first frame end.

13. The apparatus, according to claim 1, in which the rail member is disposed at an angle relative to the ground.

14. The apparatus, according to claim 1, in which the rail member is disposed generally parallel relative to the ground.

15. The apparatus, according to claim 1, in which the rail member is disposed generally orthogonal relative to the ground.

16. The apparatus, according to claim 1, is a dolly apparatus.

17. A dolly for moving a load, the dolly comprising:
a carriage having a first frame and a second frame, each of the frames having a hinge end for hingeably connecting the frames together, the first frame being adapted for mounting on a rail member to move the carriage therealong, the second frame being moveable relative to the first frame about the hinge end;
a jack assembly connected to the first and second frames, the jack assembly being actuatable to move the second frame relative to the first frame about the hinge end; and
a brake assembly located away from the hinge end, the brake assembly having a brake plate member resiliently connected to the first frame for axial movement relative thereto, and a brake plate stopper moveably connected to the first frame, the brake plate stopper being moveable between a carriage stopping configuration, in which the brake plate stopper abuttingly engages the brake plate member, and a carriage moving configuration in which the brake plate stopper is retracted away from the brake plate member.

18. The apparatus, according to claim 1, in which the first frame is generally square-shaped and includes: i) two proximal upstanding supports, each having first and second hinges for hingeably connecting the second frame thereto, and ii) two distal upstanding supports for receiving therein the first frame.

19. A brake apparatus for a carriage, the apparatus comprising:
first and second brake plate members connected for axial movement to first and second spaced apart upstanding support plates, the first and second support plates being connected to a first frame end;
first and second brake plate stopper rods slidably mounted in the respective first and second support plates;
first and second resilient members connected the respective first and second brake plate members to the respective support plates; and
an actuator bar interconnects the first and second brake plate members to the first frame end to axially move the brake plate members.
